(19) United States
(12) Patent Application Publication
(10) Pub. No.: US 2013/0295547 A1
(43) Pub. Date: Nov. 7, 2013

(54) Interactive Study Aids For Use In Association With Text Books

(71) Applicant: Michael E. Silver, Holland, MI (US)

(72) Inventor: Michael E. Silver, Holland, MI (US)

(21) Appl. No.: 13/886,122

(22) Filed: May 2, 2013

Related U.S. Application Data
(60) Provisional application No. 61/641,478, filed on May 2, 2012.

(51) Int. Cl. G09B 7/00

(52) U.S. Cl. CPC G09B 7/00
USPC 434/362

(57) ABSTRACT

A study aid includes a text book, a readable code and a computing device. The text book has at least one WorkPatch, wherein the WorkPatch comprises two components, a first component that poses a question, and a second component which assumes that a reader has answered the question, while not providing an answer. The readable code is associated with the at least one WorkPatch. The readable code is positioned proximate the WorkPatch within the text book. The computing device has a computer readable medium containing program instructions. Execution of the program instructions by the computing device carries out the steps of: reading the readable code; providing at least one hint to the answer to the first component of the WorkPatch.

### CROSS-REFERENCE TO RELATED APPLICATION

This application claims priority from U.S. Provisional Pat. App. Ser. No. 61/641,478 filed May 2, 2012, entitled “Smartphone-Interfaced Barcoded-WorkPatches for Text Books,” the entire specification of which is hereby incorporated by reference in its entirety.

### BACKGROUND OF THE DISCLOSURE

1. Field of the Disclosure

The invention relates in general to text books and learning aids, and more particularly, to an interactive interfaced learning aid that aids a student in non-passive mode learning.

2. Background Art

Unlike the passive reading (a simple one-pass read-through) of a novel for enjoyment, the reading of a text book, particularly a text book in the fields of science, engineering, math, and business/economics, is best done in an active manner due to the high density of new (to the reader) facts, definitions, nomenclature, equations, and concepts. For the purposes of this disclosure, a text book is defined as a standard work for the study of a particular subject or subjects, and may be printed on paper or be in electronic form. Traditionally an active manner has meant having some blank paper, perhaps a calculator, and a writing implement available while reading to allow for the taking of notes, the solving of practice problems imbedded in the text, and the writing down of any questions that might come up during the reading.

However, reading a text book in an active manner is often resisted by students because it takes a great deal of effort, it takes much more time than reading it in a passive manner, and it often requires reading sections of the text repeatedly. In addition, students often do not have sufficient knowledge to know where or when in the reading to switch from a passive to a non-passive mode, whereas the author, with a much more solid knowledge base and teaching experience, does. As a result, many students read text books in an almost exclusively passive manner and end up failing to fully grasp and master its content.

Text books traditionally attempt to combat this by imbedding both solved and unsolved sample and practice problems within the body of the text, which are referred to here as in-chapter problems (these are distinct from end-of-chapter problems that come after each chapter). Readers are encouraged to examine the in-chapter solved problems and try the in-chapter unsolved problems as they read, and in doing so, switch from a passive to a non-passive mode and struggle with the content to increase learning and comprehension while they read. An author will often place such in-chapter problems where he or she feels it is appropriate for the reader to switch from a passive to a non-passive mode. Unfortunately, students often still persist with passive reading and treat the in-chapter problems as if they were end-of-chapter problems to be done at some later time (or never if not assigned).

An attempt to encourage non-passive reading of text books was implemented in the text book titled Introductory Chemistry, written by Russo and Silver, now in its fourth edition (Pearson-Prentice Hall, publisher) in the form of what are referred to as WorkPatches. For the purposes of the present disclosure, a WorkPatch is defined as follows: A WorkPatch has two components. The first component is a question or exercise embedded within a chapter (as opposed to being placed at the end or after a chapter) that is purposefully not answered or solved within the chapter. The second component is the text that immediately follows the first component, refers to the answer to the first component and may also assume a comprehension of the answer to the first component but purposefully does not reveal the answer to the first component. This makes passively reading beyond the first component of a WorkPatch like coming into the middle of a conversation and makes further reading difficult, encouraging the reader to stop and actually do what the first component asks, which is to switch to a non-passive mode and come up with an answer to the first component.

A WorkPatch can be marked or unmarked, within the body of the text as opposed to being at the end of it (i.e., at the end of a chapter). However, if the reader cannot answer the first component of a WorkPatch, or check their answer so as to feel confident, further reading may be hindered. For this reason, explicit answers to the WorkPatches are placed at the end of each chapter in our text book, “hidden” from instant viewing (or otherwise that is likewise hidden from instant viewing).

Throughout all of the editions of the foregoing text book, in all of the associated external reviews, the WorkPatches have been among the most valued features for their ability to induce non-passive reading for some of the reviewers' students. However, feedback has informed us that many students still attempt to stay in an entirely passive mode while reading chapters. It is an object of the present disclosure to provide an enhancement to such WorkPatches to the reader to further encourage non-passive reading.

### SUMMARY OF THE DISCLOSURE

The disclosure as directed to the applicants' invention now addresses the need to further encourage non-passive reading of text books by the novel method that employs Smartphone-interfaced barcoded-WorkPatches. A WorkPatch is defined as follows: A WorkPatch has two components. The first component is a question or exercise embedded within a chapter (as opposed to being placed after a chapter) that is purposefully not answered or solved within the chapter. The second component is the text that follows the first component (preferably immediately), refers to the answer to the first component and may also assume a comprehension of the answer to the first component but purposefully does not reveal the answer to the first component.

Passive reading of the second component is similar to coming into the middle of a conversation and makes further reading difficult, encouraging the reader to stop and actually do what the first component asks, which is to switch to a non-passive mode and come up with an answer to the first component. A WorkPatch can be marked or unmarked, with the preferred embodiment being that it be within the body of the text as opposed to being at the end of it (i.e., at the end of a chapter). However, a significant percentage of readers still read through WorkPatches in an entirely passive mode, circumventing the effort to make them read in a non-passive manner.

To provide non-passive reading, the disclosure is directed to a study aid. The study aid comprises a text book, a readable code and a computing device. The text book has at least one WorkPatch, wherein the WorkPatch comprises two components, a first component that poses a question, and a second component which assumes that a reader has answered the question, while not providing an answer. The readable code is associated with the at least one WorkPatch. The readable code is positioned within the text book. The computing device has a computer readable medium containing program instructions. Execution of the program instructions by the computing device carries out the steps of: reading the readable code; providing at least one hint to the answer to the first component of the WorkPatch. In certain embodiments, the readable code is positioned proximate each WorkPatch, whereas in other embodiments, a single code may correspond to the WorkPatches within a chapter, section, or the entire text.

In a preferred embodiment, the computing device further carries out the step of: providing the answer to the first component.

In another preferred embodiment, the computing device further carries out the step of: providing a plurality of hints to the answer to the first component of the WorkPatch.

In another preferred embodiment, the computing device further carries out the step of: providing a teacher information about at least one of the steps of providing and reading.

In yet another preferred embodiment, the computing device further carries out the steps of: requesting a response to the first component from a user; and accepting the response to the first component from a user.

Preferably, the computing device further carries out the step of: providing the response to a teacher.

In another embodiment, the computing device further carries out the steps of: comparing the response to the answer; and providing the user a result of the step of comparing.

In another aspect of the disclosure, the disclosure is directed to a method of studying. The method comprises the steps of: reading at least one WorkPatch in a textbook, wherein the WorkPatch comprises two components, a first component that poses a question, and a second component which assumes that a reader has answered the question, while not providing an answer; locating a readable code associated with the at least one WorkPatch, the readable code being positioned within the text book; reading the readable code with a computing device, which directs the computing device to display information; reading the information provided by the computing device; and using the information to discern an answer to the at least one WorkPatch.

In a preferred embodiment, the information comprises at least one hint to the answer.

In another embodiment, the information comprises the answer.

In yet another embodiment, the method comprises the step of: providing a proposed answer to the computing device.

In another preferred embodiment, the method further comprises the step of: reading a second information provided by the computing device.

Preferably, the second information comprises at least one of a hint and an answer.

### BRIEF DESCRIPTION OF THE DRAWINGS

The disclosure will now be described with reference to the drawings wherein:

FIG. 1 of the drawings is a schematic representation of the study aid system of the present disclosure;

FIG. 2 of the drawings is a schematic representation of a general purpose computing device, which may have the components (and additional components) of the smartphone 11; and

FIG. 3 of the drawings is a flowchart of an exemplary process or method of use of the study aid system of the present disclosure.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

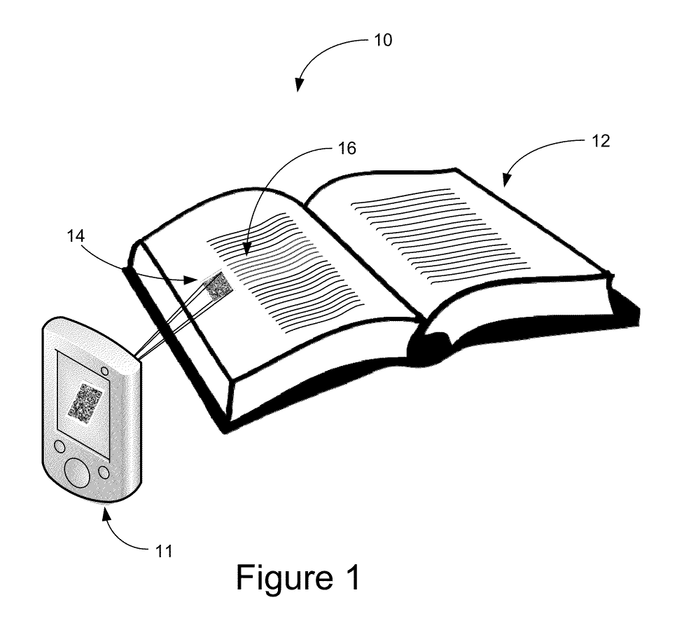

Referring now to the drawings and in particular to FIG. 1, the interactive study aid system 10 includes a text book 12, which includes within it a plurality of WorkPatches having a unique computer readable identifier positioned thereby, along with a computing device, such as smartphone 11. One such example is the QR code 14 that is positioned proximate the text (a WorkPatch) 16 on the page. The QR code, as will be explained hereinbelow, is readable by a computing device, such as a smartphone. Details pertaining to the computing device will be explained below, with the understanding that any number of different computing devices are contemplated for use, including, but not limited to smartphones.

It will be understood that although not required, aspects of the descriptions below will be provided in the general context of computer-executable instructions, such as program modules, being executed by a computing device, sensing device alone or in cooperation with other remote computing devices through outside communication (which will also be described).

More specifically, aspects of the description below will reference acts, methods and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to a specialized control module within the housing of the device, or conventional personal computers, and include other computing configurations, including hand-held devices (i.e., smartphones), multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

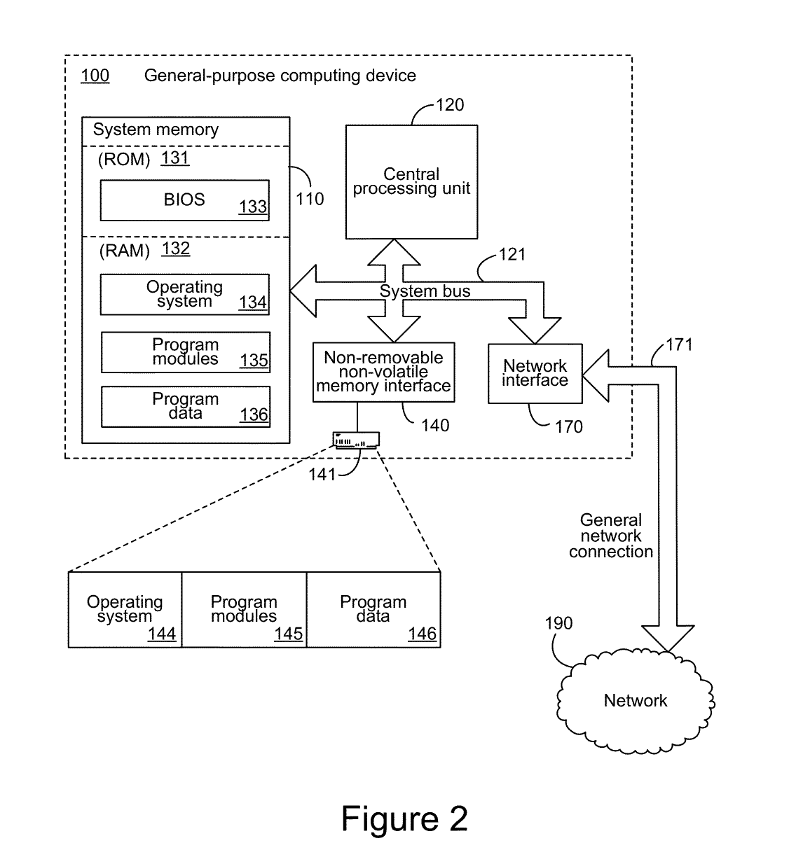

With reference to FIG. 2, an exemplary general-purpose computing device is illustrated at 100. The general-purpose computing device 100 may be of the type utilized for the smartphone 11 as well as the other computing devices which may comprise the outside computing device servers with which communication can be established. As such, it will be described with the understanding that variations can be made thereto. The exemplary general-purpose computing device 100 can include, but is not limited to, one or more central processing units (CPUs) 120, a system memory 130 and a system bus 121 that couples various system components including the system memory to the processing unit 120. The system bus 121 may be any of several types of bus structures including a memory bus or memory controller, a peripheral bus, and a local bus using any of a variety of bus architectures. Depending on the specific physical implementation, one or more of the CPUs 120, the system memory 130 and other components of the general-purpose computing device 100 can be physically co-located, such as on a single chip. In such a case, some or all of the system bus 121 can be nothing more than communicational pathways within a single chip structure and its illustration in FIG. 2 can be nothing more than notational convenience for the purpose of illustration.

The general-purpose computing device 100 also typically includes computer readable media, which can include any available media that can be accessed by computing device 100. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared, Bluetooth and other wireless media. Combinations of the any of the above should also be included within the scope of computer readable media.

When using communication media, the general-purpose computing device 100 may operate in a networked environment via logical connections to one or more remote computers. The logical connection depicted in FIG. 2 is a general network connection 171 to the network 190, which can be a local area network (LAN), a wide area network (WAN) such as the Internet, or other networks. The computing device 100 is connected to the general network connection 171 through a network interface or adapter 170 that is, in turn, connected to the system bus 121. In a networked environment, program modules depicted relative to the general-purpose computing device 100, or portions or peripherals thereof, may be stored in the memory of one or more other computing devices that are communicatively coupled to the general-purpose computing device 100 through the general network connection 171. It will be appreciated that the network connections shown are exemplary and other means of establishing a communications link between computing devices may be used.

The general-purpose computing device 100 may also include other removable/non-removable, volatile/nonvolatile computer storage media. By way of example only, FIG. 2 illustrates a hard disk drive 141 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the general-purpose computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

It will be understood that in various embodiments, it will be preferred that the computing device comprises a smartphone. A number of different devices are contemplated for use, including smartphones that operate on such operating systems as Apple's iOS, Google's Android, Microsoft's Windows Phone, Nokia's Symbian, RIM's Blackberry OS, and embedded Linux distributions such as Maemo and MeeGo. It will also be understood that such smartphones can communicate under a number of different protocols, including cellular communication (CDMA, GSM, 3G, 4G, LTE) as well as wireless protocols (WIFI, Bluetooth, and the like) with other computing devices on a network, to access the world wide web and particular website addresses associated with the same.

As will be explained with respect to the operation of such a system, each WorkPatch 16 that is presented in text book 12 includes a readable code 14. It will be understood that the readable code 14 may comprise any number of different implementations of a readable code. For example, the readable code 14 may comprise a 1D or 2D bar code. Additionally, optical character recognition can be utilized in order to read the code. In yet other embodiments, another means of readable code can be utilized. It will be understood that there is no limitation as to the different types of codes that can be utilized, with the understanding that the usable code comprises a readable code. It will be understood that it is within the scope of the disclosure, that the readable code comprises a number which is, for example, read by a user and then sent by SMS or other protocol to a particular address, or telephone number, for example.

It will be understood that a single readable code may be associated with each WorkPatch 16, and may be positioned proximate the WorkPatch. In other embodiments, a single readable code may correspond to multiple WorkPatches. That is, a single readable code may correspond to the WorkPatches of a chapter, a section, or of all of the WorkPatches in the text.

The readable code 14 is coupled to a particular url and a particular website. Of course, the readable code can also be coupled to a network wherein a response is coupled to a communication protocol (i.e., SMS or the like). Preferably, however, the readable code directs the user to a particular website, or plurality of websites. In other embodiments, an answer or a hint may be embedded within the readable code, and decipherable without specialized software associated with the text, but through conventional code reading programs (i.e., conventional QR code may include the answer or a hint embedded therewithin).

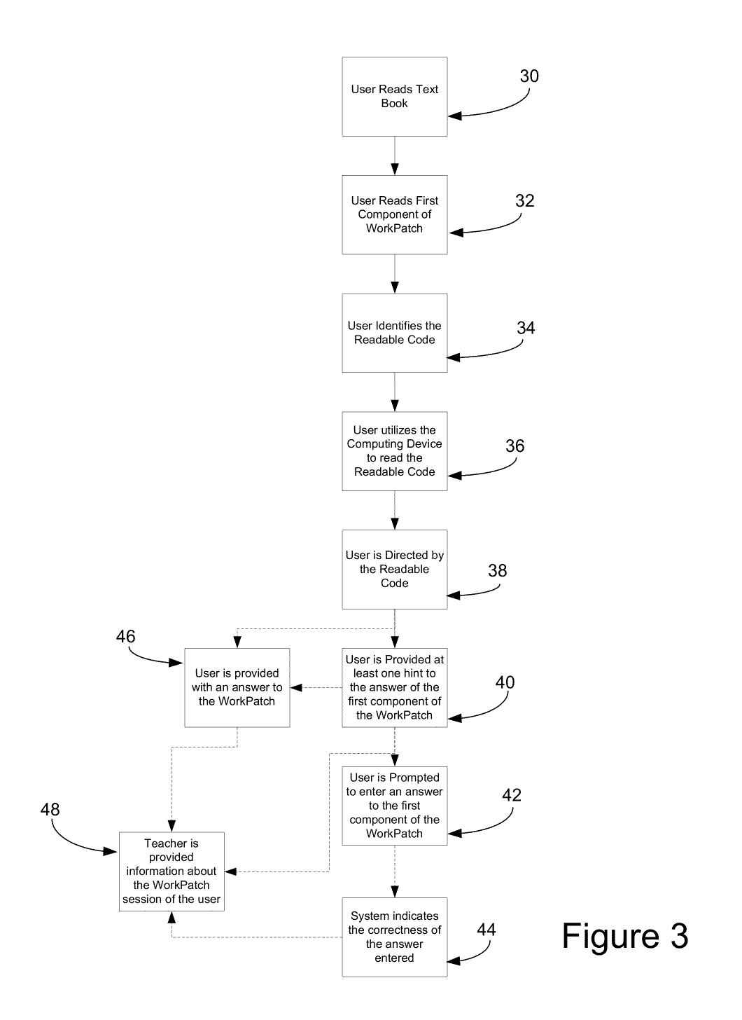

With reference to FIG. 3, a sample flowchart is provided of an exemplary use of the system, and an exemplary operation of the system and method by a student reading the text book. In particular, the user is provided with a text book having the particular

WorkPatches and associated readable codes. The user, at step 30 reads the text book in a traditional passive or non-passive manner. At step 32, the user arrives at a WorkPatch, and reads the first component (which identifies a problem that requires an answer prior to proceeding to the second component). At such time, the user studies the WorkPatch.

In the event that the user cannot determine an answer to the WorkPatch through traditional means, at step 34, the user identifies the readable code that is associated with the WorkPatch. Typically, although not required, the readable code is positioned in the margin of the text next to the WorkPatch, although placement in other locations, generally in close proximity is likewise contemplated. Once identified, at step 36, the user utilizes the computing device (in this example, a smartphone) to read the readable code. In the example, the user utilizes a camera on the smartphone to analyze the barcode (in this case QR code) that comprises the readable code.

With the smartphone coupled to a network (in this case WIFI, for example), at step 38, the user is directed to a website (a particular url, for example). Once directed to a website, a number of different functionalities can be provided. For example, the website may provide, at step 40, a hint to the first component of the WorkPatch. As such, the user is provided with some assistance in order to answer the first component. The website may include further hints or clues. Additional interaction with the website may be necessary to display can have access to the additional hints or clues. It will be understood that the information provided on the website may be in any number of different forms, including, but not limited to, text, music, voice, picture, animation, or some combination of these.

Optionally, at step 42, the user may be prompted by the website to provide an answer to the first component of the WorkPatch. In the embodiment disclosed, the answer may be provided in the form of a multiple choice question, wherein the user is to identify the correct answer from a plurality of answers. Otherwise, a blank entry portion may be provided, wherein the user provides the answer without any additional prompting.

At step 48, the system can optionally send to the instructor the answer that has been provided by the user as the response to the first component of the WorkPatch. In that way, the WorkPatches can be utilized as homework assignments, and the teacher can be provided with feedback as to the answer chosen by the user.

At step 44, the system can optionally provide a second set of information to the user in the form of an indication to the user as to the provided response to the first component of the WorkPatch. For example, a simple right or wrong indicator can be provided to the user. In other embodiments, the system can provide not only such an indication, but also an explanation as to the correct answer. It will also be understood that this second information may comprise a second hint, in the event that the user's response is not the correct answer.

At step 46, rather than providing a hint, the system can merely provide the answer to the user. It will be understood that step 46 can occur as soon as the user reads the readable code, or may occur after a single or multiple hints have been provided (i.e., such as at step 40).

Additionally, optionally, the system may track the user's interaction with the website associated with the WorkPatch. For example, any number of data can be captured through the interaction. Among other data, data pertaining to the user's access to the website (i.e., the mere fact that the user has read the code) can be tracked. Additionally, time spent on the website can be tracked, along with, for example, the receipt of hints, as well as the number of hints. This information can be utilized by the teacher, the book author or the publisher in any number of different forms. For example, the data can provide an impetus for future changes to the book. Additionally, such information can be utilized by the teacher to judge relative difficulties of different concepts, the time spent on studying by the users, the proper focal point for classroom discussion and the like.

It will be understood that any number of WorkPatches can be provided in a text book, and the different WorkPatches and associated readable codes can operate in a different manner, and may have different criteria (i.e., providing a hint, multiple hints, answers and the like). Each WorkPatch may be handled differently. In addition, teacher settings may be employed which can control whether a hint, multiple hints, answers are provided, answer are sought, etc. As such, the teacher can customize the particular WorkPatches to achieve different teaching goals.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A study aid system comprising:
a text book having at least one WorkPatch, wherein the WorkPatch comprises two components, a first component that poses a question, and a second component which assumes that a reader has answered the question, while not providing an answer;
a readable code associated with the at least one WorkPatch, the readable code positioned within the text book; and
a computing device having a computer readable medium containing program instructions, wherein execution of the program instructions by the computing device carries out the steps of:
reading the readable code; and
providing at least one hint to the answer to the first component of the WorkPatch.

2. The study aid system of claim 1 wherein the computing device further carries out the step of:
providing the answer to the first component.

3. The study aid system of claim 1 wherein the computing device further carries out the steps of:
providing a plurality of hints to the answer to the first component of the WorkPatch.

4. The study aid system of claim 1 wherein the computing device further carries out the steps of:
providing a teacher information about at least one of the steps of providing and reading.

5. The study aid system of claim 1 wherein the computing device further carries out the steps of:
requesting a response to the first component from a user;
accepting the response to the first component from a user.

6. The study aid system of claim 5 wherein the computing device further carries out the step of:
providing the response to a teacher.

7. The study aid system of claim 5 wherein the computing device further carries out the steps of:
comparing the response to the answer; and
providing the user a result of the step of comparing.

8. A method of studying comprising the steps of:
reading at least one WorkPatch in a textbook, wherein the WorkPatch comprises two components, a first component that poses a question, and a second component which assumes that a reader has answered the question, while not providing an answer;
locating a readable code associated with the at least one WorkPatch, the readable code being positioned within the text book;
reading the readable code with a computing device, which directs the computing device to display information;
reading the information provided by the computing device; and
using the information to discern an answer to the at least one WorkPatch.

9. The method of claim 8 wherein the information comprises at least one hint to the answer.

10. The method of claim 8 wherein the information comprises the answer.

11. The method of claim 8 further comprising the step of:
providing a proposed answer to the computing device.

12. The method of claim 11 further comprising the step of:
reading a second information provided by the computing device.

13. The method of claim 12 wherein the second information comprises at least one of a hint and an answer.
